(19) United States
(12) Patent Application Publication
(10) Pub. No.: US 2014/0231361 A1
(43) Pub. Date: Aug. 21, 2014

(54) METHOD AND APPARATUS FOR PROCESSING ACIDIC SEA WATER

(71) Applicant: Sigan PENG, Wuhan City (CN)

(72) Inventor: Sigan PENG, Wuhan City (CN)

(21) Appl. No.: 14/146,346

(22) Filed: Jan. 2, 2014

Related U.S. Application Data
(63) Continuation of application No. PCT/CN2012/077718, filed on Jun. 28, 2012.

(30) Foreign Application Priority Data
Jul. 1, 2011 (CN) 201110184097.2

(51) Int. Cl. C02F 1/66; C02F 1/74; B63J 4/00

(52) U.S. Cl. CPC C02F 1/66; B63J 4/006; C02F 1/74; C02F 2103/08
USPC 210/747.6; 210/747.5; 210/220

(57) ABSTRACT

A method and an apparatus for processing acidic seawater is disclosed, wherein the acidic seawater is firstly mixed with alkaline seawater, and neutralizing seawater after mixing is transferred into an aeration vessel to be aerated. The volume R of the used aeration vessel and the amount of neutralizing seawater which needs to be processed satisfy a measure relationship: R=(0.008−0.3)L, and the amount of the air brown into the aeration vessel Q, R, and L satisfy a measure relationship: Q=(25−85)L/R. The method and apparatus can be used for processing acidic seawater which rinsed the exhaust of the internal combustion engine, and they are particularly suitable for but not limited to ships, well drilling, floating factories and other offshore platforms.

### FIELD OF THE INVENTION

The invention relates to a method for processing acidic seawater and, more particularly, to a method for processing acidic seawater which have rinsed exhaust gases from an internal combustion engine. The invention also relates to an apparatus for processing acidic seawater. The method and apparatus of the invention is particularly suitable for, but not limited to ships, well drilling, floating factories and other offshore platforms.

### DESCRIPTION OF THE PRIOR ART

In the past 20 years, international legislation on purification of SO₂ based gaseous pollutants emitted from industrial facilities is gradually becoming more rigorous and comprehensive. In recent years the regulated objects have been extended from land-based industrial facilities to sea-based ships. The international legislation restricting the oxysulfide emissions from internal combustion engines of ships and etc. has come into effect in 2005.

The process for purifying the oxysulfide from mineral fuel by rinsing with natural seawater is applied in the land-based coal electricity plant maturely. A representative solution for the application of flue gas desulfurization with seawater in ships is disclosed by an international application PCT/CN2008/071304 (incorporated herein by reference). The technical scheme adopted by this invention is that making seawater flowing from top to bottom rinse the exhaust of the internal combustion engine at a padding rinsing layer in a counter-flow mode to absorb SO₂, which solves the problem mentioned above effectively.

After processing the exhaust of the internal combustion engine using the scheme provided by the international application with the application No. of PCT/CN2008/071304, the seawater for rinsing absorbs a large amount of SO₂ to be acidic seawater, with a PH value of about 3. Directly discharging such kind of acidic seawater to sea is prohibited. To reduce the effect on the environment, the PH value of the seawater to be discharged needs to be increased to approximate at least that of seawater (generally, higher than pH 6.5).

For the land-based coal electricity plant, there are related solutions for processing the acidic seawater which absorbed SO₂. However, since the limited space of the offshore platforms such as ships is enough for the aeration basin of a large size, these solutions cannot be adopted in the offshore platforms such as ships directly.

To solve the relative problems mentioned above in the prior art, the object of the invention is to provide an acidic seawater processing solution applicable for offshore platforms such as ships.

### SUMMARY OF THE INVENTION

The first object of the invention is to provide a method for processing acidic seawater, for processing seawater which has absorbed SO₂ or has rinsed exhaust gases from an internal combustion engine to eliminate the acidity, and then discharging it into the sea in an environmentally friendly way.

The method for processing the acidic seawater provided by the invention is based on the following principle.

Seawater has good absorbency for sulfur dioxide, and the seawater which rinsed and absorbed sulfur dioxide is acidic, so that it needs to be processed to increase the pH value before it is discharged to the natural seas. Therefore, alkaline seawater is firstly added into the acidic seawater with very low pH value discharged in a rinsing process to make the pH value pre-increase to be higher than or equal to 5.5, and then air is bubbled in. The procedure of adding the alkaline seawater to increase pH value utilizes the alkalinity of the alkaline seawater to neutralize the acidic seawater, thus to neutralize the dissolved sulfur dioxide, namely, free sulfurous acid to get sulphite. At that moment, the pH value of the processed seawater is increased to be higher than or equal to 5.5. Thereafter, to make the pH value of the seawater to keep increasing to reach the value (generally higher than or equal to 6.5) allowable for discharge, a large amount of alkaline seawater needs to be added additionally, which increases the energy consumption for lifting and transferring the seawater. The method of bubbling air to seawater adopted herein also may keep increasing the pH value of seawater to reach a value allowable for discharge. When the pH value of the processed seawater is lower than 5.5, bubbling air would result in the escape of SO₂. When the pH value is too high, bubbling air would decrease the process efficiency. Therefore, air is bubbled in after the pH value of the processed seawater is adjusted to be higher than or equal to 5.5. Bubbling air is an aerating process and is a procedure of continuously bubbling air to the flowing processed seawater, and the effect thereof depends on the flow of the bubbled in air, the flow of the processed seawater and the volume of the aeration vessel. In the above three factors, the flow of the processed seawater is related to the engine displacement and sulphur content of the fuel, the flow of the brown air is related to the flow of the processed seawater and the volume of the aeration vessel, and the volume of the aeration vessel is not only related to flow of the brown air and the flow of the processed seawater, but also restricted by the space of the application place. When applied in a land-based coal electricity plant, the space of the application space is not a restricting factor. The prior art often needs a quite large process space, so that it cannot be directly applied to compact space such as offshore platforms. To overcome the deficiencies in the prior art, the present invention provides a method for decreasing the space occupied by the seawater rinsing process device: continuously bubbling air to flowing processed seawater, wherein volume of the aeration vessel, amount of the neutralizing seawater which is processed and amount of the air which is bubbled in satisfy following equations (I) and (II):

R=(0.008−0.3)L (I)

Q=(25−85)L/R (II)

R in the equation is the volume of the aeration vessel (m³); L is the amount of the seawater which needs to be processed per hour (m³); Q is amount of the air which is bubbled in per hour (Nm³), which is calculated under standard state (0° C. and one atmospheric pressure). Thus, the acidic rinsing water may be processed to be nearly neural and then discharged to sea.

Therefore, the method for processing the acidic seawater provided by the invention includes:

1) mixing the acidic seawater with alkaline seawater to obtain neutralizing seawater;

2) making the neutralizing seawater continuously flow in an aeration vessel and continuously bubbling air, wherein volume of the aeration vessel R, amount of the neutralizing seawater which needs to be processed L and amount of the air which is bubbled in Q satisfy following equations (I) and (II):

R=(0.008−0.3)L (I)

Q=(25−85)L/R (II)

R in the equation is the volume of the aeration vessel, with a unit m³; L is the amount of the neutralizing seawater which is processed per hour, with a unit m³; Q is amount of the air which is bubbled in per hour, with a unit Nm³, which is calculated under standard state, that is, 0° C. and one atmospheric pressure.

The acidic seawater mentioned herein may be seawater which absorbed SO₂, such as seawater which rinsed exhaust of an internal combustion engine, such as a shipping internal combustion engine. The alkaline seawater mentioned herein is seawater with a pH value higher than 7. Since natural seawater is usually alkaline, in a preferred embodiment, the alkaline seawater is natural seawater obtained from sea, that is, fresh seawater.

The aeration vessel mentioned herein is a vessel for containing seawater and aerating. The vessel may have any shape suitable for reaction between seawater and air.

In a preferred embodiment, the pH value of the seawater after mixing the acidic seawater and the alkaline seawater to neutralize it is 5.5-6.4.

As a preferred scheme, the pH value of the processed acidic seawater is increased to 6.5-7, that is, the pH value of the neutralizing seawater discharged from the aeration vessel is 6.5-7. Thus, the requirement for discharging to the sea is met. The other objective of the present invention is to provide a acidic seawater processing apparatus for processing seawater which absorbed SO₂ or rinsed exhaust of an internal combustion engine to eliminate the acidity, and then to discharge it into the sea in an environmental friendly way.

The apparatus for processing acidic seawater provided by the present invention includes:

an aeration vessel for reaction between the acidic seawater and air, and an aeration device for aerating the aeration vessel;

volume of the aeration vessel is configured according to a following equation (I):

R=(0.008−0.3)L (I);

R in the equation is the volume of the aeration vessel, with a unit m³; L is the amount of the neutralizing seawater which needs to be processed per hour, with a unit m³.

In addition, the aeration device may be configured to have an expected aerating amount. Therefore, in a preferred embodiment, as a preferred scheme, the aeration device is configured to have aerating amount Q, which is calculated according to a following equation (II):

Q=(25−85)L/R (II)

Q in the equation is amount of the air which needs to be bubbled in per hour, with a unit Nm³, and which is calculated under standard state, that is, 0° C. and one atmospheric pressure.

The method and the apparatus for processing acidic water provided by the present invention can decrease the space occupied for processing rinsing desulfurization seawater greatly and save water, and it can be used in the offshore platforms such as ships. The environmental protection requirement that the pH value of rinsing desulfurization seawater eventually discharged is higher than or equal to 6.5 is met, thus the application of rinsing desulfurization via seawater, which is recognized as a green emission reduction process, on compact space of the offshore platforms such as ships is achieved after the successful application in land-based coal electricity plant.

### BRIEF DESCRIPTION OF THE DRAWINGS

FIG. 1 is a schematic diagram of a device for processing acidic seawater in a first embodiment of the invention;

FIG. 2 is a schematic diagram of a device for processing acidic seawater in a second embodiment of the invention.

### DETAILED DESCRIPTION OF THE PREFERRED EMBODIMENTS

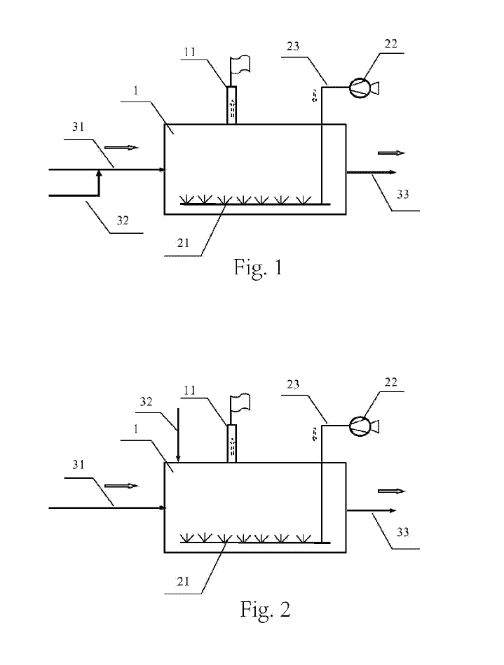

FIG. 1 shows an apparatus for processing acidic seawater in a first embodiment of the invention. As shown in FIG. 1, the apparatus for processing acidic seawater in the embodiment includes an aeration vessel 1, an aeration device, a first pipeline 21, a second pipeline 32 and a third pipeline 33.

Wherein, the aeration vessel 1 is used for reaction between the seawater and the air. A gas discharging pipe 11 for discharging the gas generated after the reaction is disposed at the aeration vessel 1.

The first pipeline 31 is used for transferring the acidic seawater to the aeration vessel 1. The second pipeline 32 is used for transferring the alkaline seawater to the first pipeline 31 in which the acidic seawater is mixed with the alkaline seawater. The third pipeline 33 is used for discharging the seawater after the reaction.

The aeration device is used for aerating the aeration vessel, and it includes an aeration head 21, an air blower 22 and an aeration pipe 23. There are multiple aeration heads 21 evenly distributed at the bottom of the aeration vessel 1.

Tests are performed for relative parameters of the apparatus for processing the acidic seawater in the embodiment. The seawater which needs to be processed is the acidic rinsing water which rinsed the exhaust of internal combustion engine of a ship and whose pH value approximates 3. After it is mixed with alkaline seawater, neutralizing seawater is formed. The alkaline seawater is obtained from natural seawater. The supplying amount of the alkaline seawater is adjusted according to whether pH value of the neutralizing seawater reaches 5.5-6.0. If the pH value is lower than 5.5, the supplying amount should be increased. If the pH value is higher than 6.0, the supplying amount should be decreased. The amount of the neutralizing seawater entering into the aeration vessel eventually is controlled to be about 760 m³/h. The volume of the aeration vessel is about 6 m³ if it is 0.008 times the amount of the neutralizing seawater which needs to be processed per hour. After doing a test, it was found that if the aerating mount of the aeration device is controlled to be [(25−85)/0.008 ]m³/per hour, the pH value of the discharged neutralizing seawater would be 6.5-7. The volume of the aeration vessel is about 230 m³ if it is 0.3 times the amount of the neutralizing seawater which needs to be processed per hour. After doing a test, it was found that if the aerating mount of the aeration device is controlled to be [(25−85)/0.3]m³/per hour, the pH value of the discharged neutralizing seawater would be 6.5-7. To coordinate the volume of the aeration vessel and the aerating amount in a better way, it may be preferably set as R=(0.05−0.2)L.

FIG. 2 shows an apparatus for processing acidic seawater in a second embodiment of the invention. Different from the apparatus for processing acidic seawater in the first embodiment, the second pipeline 32 directly transfers the alkaline seawater to the aeration vessel 1 in which the acidic seawater neutralizes the alkaline seawater and then aeration is performed.

What is claimed is:

1. A method for processing acidic seawater, comprising:
a) mixing the acidic seawater with alkaline seawater to obtain neutralizing seawater;
b) making the neutralizing seawater continuously flow in an aeration vessel and continuously bubbling air therein, wherein volume of the aeration vessel R, amount L of the neutralizing seawater which needs to be processed and amount Q of the air which is bubbled in satisfy following equations (I) and (II):
R=(0.008−0.3)L (I)
Q=(25−85)L/R (II)
R in the equation is the volume of the aeration vessel, with a unit m³; L is the amount of the neutralizing seawater which is processed per hour, with a unit m³; Q is amount of the air which is bubbled in per hour, with a unit Nm³, and which is calculated under standard state, that is, 0° C. and one atmospheric pressure.

2. The method for processing acidic seawater according to claim 1, wherein R=(0.05−0.2) L.

3. The method for processing acidic seawater according to claim 1, wherein the acidic seawater is the seawater which has absorbed SO₂.

4. The method for processing acidic seawater according to claim 1, wherein the acidic seawater is seawater which rinsed exhaust gases from an internal combustion engine.

5. The method for processing acidic seawater according to claim 4, wherein the internal combustion engine is a shipping internal combustion engine.

6. The method for processing acidic seawater according to claim 1, wherein the alkaline seawater is the seawater with a pH value higher than 7.

7. The method for processing acidic seawater according to claim 1, wherein the alkaline seawater is natural fresh seawater obtained from sea.

8. The method for processing acidic seawater according to claim 1, wherein a pH value of the neutralizing seawater is ranging from 5.5 to 6.4.

9. The method for processing acidic seawater according to claim 1, wherein the acidic seawater and the alkaline seawater are mixed before and/or after entering the aeration vessel.

10. The method for processing acidic seawater according to claim 1, wherein the aeration vessel communicates with a first pipeline for transferring the acidic seawater, and the alkaline seawater is transferred to the first pipeline via a second pipeline and mixed with the acidic seawater in the first pipeline.

11. The method for processing acidic seawater according to claim 1, the aeration vessel communicates with a first pipeline for transferring the acidic seawater and a second pipeline for transferring the alkaline seawater, respectively, and the acidic seawater and the alkaline seawater are mixed in the aeration vessel.

12. The method for processing acidic seawater according to claim 1, wherein a pH value of the neutralizing seawater discharged out of the aeration vessel is ranging from 6.5 to 7.

13. An apparatus for processing acidic seawater, comprising:
an aeration vessel for reaction between the acidic seawater and air, and an aeration device for aerating the aeration vessel;
wherein volume of the aeration vessel is configured according to a following equation (I):
R=(0.008−0.3)L (I);
R in the equation is the volume of the aeration vessel, with a unit m³; L is amount of the seawater which needs to be processed per hour, with a unit m³.

14. The apparatus for processing acidic seawater according to claim 13, wherein R=(0.05−0.2)L.

15. The apparatus for processing acidic seawater according to claim 13, wherein the aeration device is configured to have aerating amount Q, which is calculated according to a following equation (II):
Q=(25−85)L/R (II)
Q in the equation is amount of the air which needs to be bubbled in per hour, with a unit Nm³, and which is calculated under standard state, that is, 0° C. and one atmospheric pressure.

16. The apparatus for processing acidic seawater according to claim 13, wherein the aeration vessel communicates with a first pipeline for transferring the acidic seawater, and the first pipeline communicates with a second pipeline for transferring alkaline seawater.

17. The apparatus for processing acidic seawater according to claim 13, the aeration vessel communicates with a first pipeline for transferring the acidic seawater and a second pipeline for transferring alkaline seawater, respectively.
